(19) United States
(12) Patent Application Publication
(10) Pub. No.: US 2017/0150195 A1
(43) Pub. Date: May 25, 2017

(54) METHOD AND SYSTEM FOR IDENTIFYING AND TRACKING ONLINE VIDEOS

(71) Applicants: LEI YU, Hangzhou (CN); Yangbin Wang, Palo Alto, CA (US)

(72) Inventors: LEI YU, Hangzhou (CN); Yangbin Wang, Palo Alto, CA (US)

(21) Appl. No.: 15/422,133

(22) Filed: Feb. 1, 2017

Related U.S. Application Data
(63) Continuation-in-part of application No. 14/501,826, filed on Sep. 30, 2014.

(51) Int. Cl. H04N 21/24; H04N 21/438; H04L 12/24; H04N 21/41

(52) U.S. Cl. CPC H04N 21/2407; H04N 21/2404; H04N 21/4126; H04N 21/4383; H04L 41/0654

(57) ABSTRACT

A method and system of identifying and tracking online videos comprises the steps of searching and discovering targeted video on the Internet, filtering out manageable amount of online videos from large amount of search results of the targeted video, acquiring online video contents through websites, identifying acquired videos by their contents, and generating different tracking reports according to video identification results and other historical records.

### CROSS-REFERENCE TO RELATED APPLICATIONS

The present application is a Continuation-in-Part of U.S. application Ser. No. 14/501,826, filed Sep. 30, 2014, entitled “METHOD AND SYSTEM FOR IDENTIFYING AND TRACKING ONLINE VIDEOS” and which is incorporated herein by reference and for all purposes.

### BACKGROUND OF THE INVENTION

Field of the Invention

The present invention relates to a method and system for identifying and tracking online videos, including video content search and discovery throughout the Internet, acquiring video contents from websites and identifying video contents using Video DNA (VDNA) technology. Specifically, the present invention relates to facilitating tracking video contents over the Internet.

Description of the Related Art

Video contents sharing on the Internet has been through a tremendous boost in recent years, websites hosting video contents are becoming so popular that they even take over a very large proportion of the Internet traffic. Present online video contents are easily accessible via different terminals, from personal computers, tablets, mobile devices etc, and different channels such as online video websites which are authorized by content owners, UGC (User Generated Content) websites, P2P (Point-to-Point) networks and so on.

Some of the distinct characteristics of online video contents include a) massive distribution amount, b) multiple content sources, c) high-speed propagation over the whole network, and d) rapid updates of the contents, which make it a tough challenge for content owners attempting to protect and track the usage of their contents on the Internet. Although it is a trend that content owners apply Internet and online video sites or terminals as one of their content distribution channels, there are a number of issues they concern which have no significant solutions by conventional methods as in traditional video content distribution channels. Such issues that content owners concern include:
illegal copies of video contents propagating on the Internet, on unauthorized sites or terminals;
audience rating of the video contents is not as visible as contents distributed via traditional channels, e.g. box office, DVD (digital versatile disc or digital video disc) sales report, etc;
audience preferences over the video contents, or even certain parts of the video content, are valuable data which content owners may be interested.

On the top of the above said issues, illegal copies of video contents are seen mostly on UGC websites and P2P networks. UGC websites are protected by safe harbor of the DMCA (Digital Millennium Copyright Act). In order to protect video contents, content owners are required to discover illegal contents presented on UGC websites and post take down notices.

There are many P2P networks on the Internet such as BT (Bit Torrent), eD2k (eDonkey 2000), Magnet and so on. There are two types of P2P networks: one has center nodes such as BT and eD2k while other types have no center nodes such as Kad and Magnet, etc.

On the centered P2P networks, peers must connect to one or more center nodes to share files. For example, eD2k network have servers working as center nodes. When a client startups, it will connect to one or more servers, then send its shared file list to server. Server will maintain a known shared file list. When searching targeted files, the client will send a search instruction to the server which it connects to all known servers. Server who receives a search request will do a search in its known shared file list and send the search result to the client. When downloading, the peer will send an instruction to the server which it connects to all servers that it knows to tell which peer having the content of the targeted files. Then the peer will ask other peers told by server to exchange source and content, where the sources can be more servers and peers together with shared files.

On P2P networks without center nodes, peers record an active peer list for every boot startup. When booting, peer loads the list of known peers, then tries to connect to every peer. If successfully connected to one peer, it can retrieve more sources from that peer. Peers in this type of P2P networks that have no center nodes work as clients as well as servers. It communicates to each known active peers and helps exchanging data between each peer.

File sharing on centered P2P networks can be prevent by killing all center nodes. Many famous centered P2P networks such as eDonkey have been shutdown for illegal attack. But P2P networks without center nodes can not be shutdown by killing one or more nodes, as they are contributed by a huge amount of peers. It is not possible to prevent people from using those type of P2P networks, and so, file sharing on P2P networks can not be controlled by anyone.

Conventional methods of searching and discovering video content copies include:
using keywords to search in search engines, analyzing from search results based on keywords or tags;
search by keywords or tags in video contents sharing websites or UGC websites, analyzing from search results based on keywords or tags;
using digital watermarks on all registered video contents, and discover by matching the digital watermarks.

There are several disadvantages about this method:
1. keywords or tags search is semantics based, which works fine with documents or information described by texts, yet it has weak accuracy as to identify video contents;
2. such searching and discovering method cannot provide sufficient evidence to demand UGC websites to take down illegal copies of contents;
3. embedding digital watermarks break the integrity of the original video contents.

Although there are some means to help to improve the disadvantages mentioned above, yet most of them require human operations intervened, for example to increase the accuracy of video identification from the text based search results, they are required to manually check the contents of the video, which determines that such methods are not scalable, let alone to optimize with limited resources to handle massive amount of information on the Internet.

Ways to automatically search and discover video contents over the Internet, and automatically identify and track the video contents is hence desirable, so that no or few human operations are involved in the whole process. With the help of a mature video identification technology, given required metadata from content owners, the system is able to track the usage of the targeted content all over the Internet.

### SUMMARY OF THE INVENTION

An object of the invention is to overcome at least some of the drawbacks relating to the prior arts as mentioned above.

Conventional online video tracking in order to prevent piracy or acquire statistics of the usage of online distributed content either is not accurate by using textual keywords search on the metadata information of the video content, or requires a lot of human efforts to collect and identify massive amount of online videos. However in the present invention, the video tracking system is equipped with online content discovery and identification sub systems, which enables automatic online content tracking with no or few human efforts involved.

An object of the present invention is to automatically and accurately identify and track targeted video contents over the Internet, by using limited resources to cover massive amount of information on the Internet. The present invention comprises steps of searching and discovering targeted video on the Internet, filtering out manageable amount of online videos from large amount of search results of the targeted video, acquiring online video contents through websites, identifying acquired videos by their contents, and generating different tracking reports according to video identification results and other historical records.

The process of “search and discovery” includes using a set of predefined keywords, applying mature Internet crawler technology to search throughout an augmented list of websites which is created and managed by a Search and Discovery System based on the whole network that executes keyword based search throughout the entire Internet, captures text contents from targeted websites, and from captured text information, wherein the Search and Discovery System discovers new websites, and adds it to the augmented list after confirming from administrator.

Searching and discovering targeted videos on Internet not only crawl on websites using HTTP (Hypertext Transfer Protocol) protocol, but also track on different kind of networks such as P2P networks.

When P2P networks have many entries, websites can share P2P resources by offering P2P links such as ed2k and magnet and so on. P2P networks also have entries for user to find out resources that they want. Videos shared on P2P networks follow the same way as other resources.

Search and discovery on P2P networks start from the information outside the P2P network together with entry provided by P2P networks. Entries outside the P2P networks can be found by other crawlers, for example, http crawler can find P2P links on linking site. After finding out the entry of P2P networks, the search and discovery system walks in to the P2P network. It uses keyword search to find out title-related resources. After finding out these resources, the system tries to get everything provided by P2P network, and sends them to the filter system. Filter system checks information defined by template system of every resource to filter out resources and sends resources to identification system.

The P2P network has a feature with contents generated by users and transmitting between users, so the discovery system gets resources as entry to discover users who own content of the resource. After finding users, the system may get a list of files shared by users. The system may find more targeted files by doing that.

The identification system gets the content of known P2P resource by downloading them using P2P protocol and identifies it with the same steps of other networks.

Based on the macro level amount of information on the Internet, the results which are discovered from the above step are also massive. Hence before actually processing the video contents, the system performs a filtration over the discovered video contents by multiple pre-defined filtering criteria. A manageable amount of verification candidates are filtered out and ready for identification.

The essence of video content identification technology is to take advantage of the high speed processing of the computers to ingest characteristic values of each frame of image and audio from video contents, as called “VDNA (Video DNA)”, which are registered in a centralized database for future reference and query. Such process is similar to collecting and recording human fingerprints. One of the remarkable usages of VDNA technology is to rapidly and accurately identify video contents, so that to protect copyright contents from being illegally used on the Internet.

Due to the fact that VDNA technology is entirely based on the video content itself between video content and generated VDNA, there is a one-to-one mapping relationship. Compared to the conventional method of using digital watermark technology to identify video contents, VDNA technology does not require to pre-process the video content to embed watermark information. VDNA technology greatly adapts the characteristics of current online video contents: massive distribution amount, multiple content sources, high-speed propagation over the whole network, and rapid updates of the contents, making it much easier and more effective for content owners to track their registered contents over the Internet.

In summary, the present invention takes advantage of the properties of computers: high speed, automatic, huge capacity and persistent, and tracks targeted video contents through massive amount of information on the Internet, makes it possible for content owners to automatically, accurately and rapidly protect registered video contents online.

In other aspect, the present invention also provides a system and a set of methods with features and advantages corresponding to those discussed above.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows schematically a component diagram of each functional entity in the system according to the present invention.

FIG. 2 is a block diagram illustrating a number of steps in the searching and discovering process according to the present invention.

FIG. 3 is a block diagram depicting the filtration process and criteria according to the present invention.

FIG. 4 is a flow chart showing a number of steps in the identification process according to the present invention.

FIG. 5 is a block diagram to demonstrate the perspective of the users of the video tracking system on some operations and overall concerns.

FIG. 6 illustrates the overall architecture of the system monitoring multiple TV broadcasting networks.

FIG. 7 illustrates the channel confirm mechanism using video and audio identification and comparing.

FIG. 8 illustrates the case where a failed channel is discovered and replaced.

Like reference numerals refer to like parts throughout the several views of the drawings.

### DESCRIPTION OF THE PREFERRED EMBODIMENT

The present invention now will be described more fully hereinafter with reference to the accompanying drawings, in which some examples of the embodiments of the present inventions are shown. Indeed, these inventions may be embodied in many different forms and should not be construed as limited to the embodiments set forth herein. Rather, these embodiments are provided by way of example so that this disclosure will satisfy applicable legal requirements. Like numbers refer to like elements throughout.

Conventional online video tracking in order to prevent piracy or acquire statistics of the usage of online distributed content either is not accurate by using textual keywords search on the metadata information of the video content, or requires a lot of human efforts to collect and identify massive amount of online videos. However in the present invention, the video tracking system is equipped with online content discovery and identification sub systems, which enables automatic online content tracking with no or few human efforts involved.

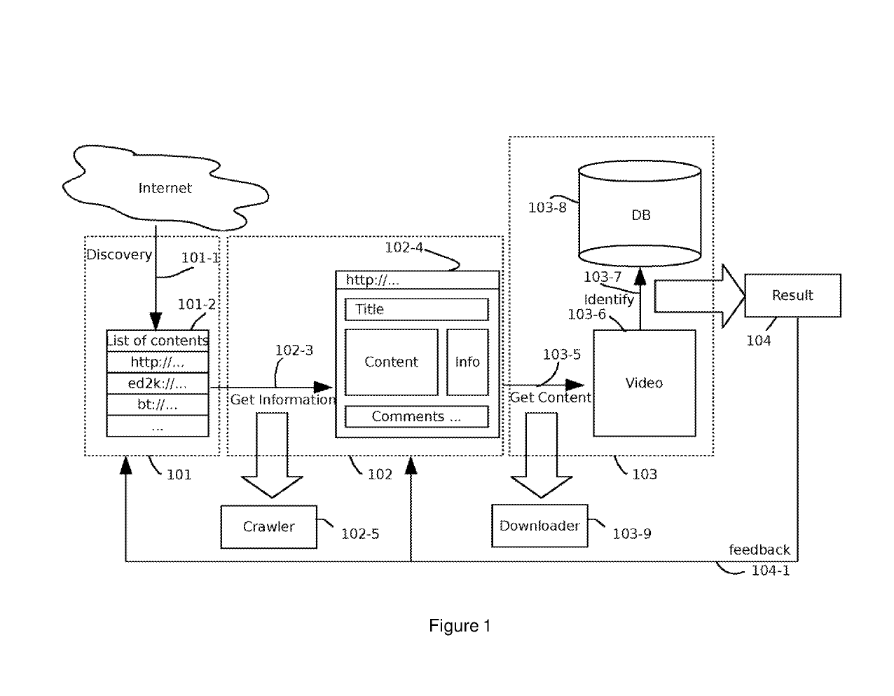

FIG. 1 illustrates main functional components of the video tracking system, in which component 101 represents the search and discovery subsystem. The component 101 is capable of performing keyword-based crawl (102-5) throughout an augmented list of websites on p2p resources, as referred to 101-2, to heuristically search and discover targeted video contents. The augmented list is created and managed by the search and discovery subsystem based on the whole Internet, which executes keyword based search throughout the entire Internet, captures text contents from targeted websites. From captured text information, the search and discovery subsystem discovers new websites, and adds it to the augmented list after confirming from administrator. Moreover, the targeted digital video files searched by the search and discovery subsystem can be in any valid video format, as long as it can be decoded by computer.

The component 102 from FIG. 1 depicts the filtration subsystem of the video tracking system. As pointed by action 101-1, the object of search and discovery subsystem is the contents from the entire Internet, needless to say that, the generated results of search and discovery will be still massive. The purpose of component 102 is to reduce the level of magnitude to a manageable amount for limited resources. The filtration subsystem adapts to all protocols supported by component 101, including websites using HTTP and P2P resources such as ED2K and BIT-TORRENT (BT). There are two means to achieve the purpose of video content filtration, 1) preprocessing of text-based video metadata, and 2) identification of limited size of video content.

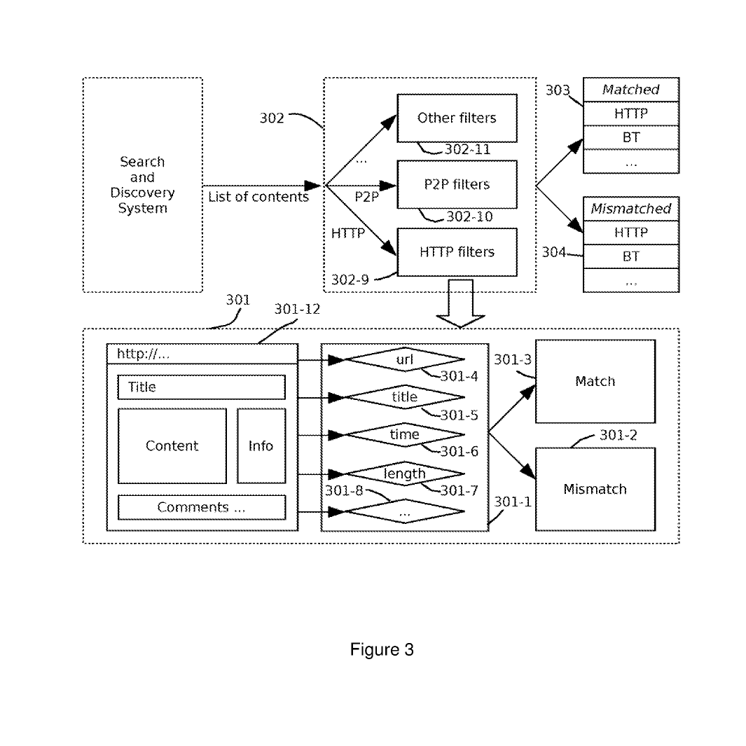

102-4 demonstrates an example of text-based preprocessing method used to filter video contents embedded in an online video website. A typical online video embedded webpage always shares the video content accompanied by different kind of metadata of the video, such as video title, publishing date, casts, comments by audiences, links to other relevant video content webpages or resources, all of these are valuable information to filter out best candidates for video content identification process. P2P networks also have meta information of the shared video such as video title, video size, comments by content owners and number of sources and so on, and all of those are valuable information to filter out best candidates for video content identification process like videos shared on HTTP webpages. Another filtration method is identification of limited size of video content, which takes advantage of the highly efficient and compact features of VDNA technology, which can preprocess only the first few parts of the video contents to make a decision whether or not the current video should be included in the best candidate queue for full identification process. The component 102 will be fully explained in FIG. 3.

The size of the best candidate queue after processed by filtration subsystem is manageable by limited resources, wherein the mentioned resources include hardware limitation, bandwidth limitation, etc. Since such limitations are flexible in different environments, it requires the whole system to be scalable among different configurations of resources.

The component 103 of FIG. 1 illustrates the video content identification and match subsystem. The subsystem 103 handles each entry inside the filtered candidate queue, in which subsystem 103 identifies every video contents using VDNA technology, by matching registered target video VDNA characteristics in dedicated database. VDNA technology refers to the video content identification technology to take advantage of the high speed processing of the computers to ingest (as is illustrated by action 103-6) characteristic values of each frame of image and audio from video contents. By matching video contents using VDNA technology, it guarantees the genuine of the identification result, overcomes some disadvantages of conventional video content identification methods, for example, it is fully automatic, without human operations intervened, and it preserves the integrity of the targeted video which in the sense that no digital watermarks or other form of tags are embedded inside the target video content. It is also remarkable that VDNA ingestion supports any valid format of video contents.

103-8 is another crucial component of video content identification and match subsystem. It's a sophisticatedly designed and dedicated database for registering and matching VDNA samples.

The identification result (104) of video contents will also be used as feedback (104-1) to improve the discovery and filtration process, continuously making these routines more accurate and swift.

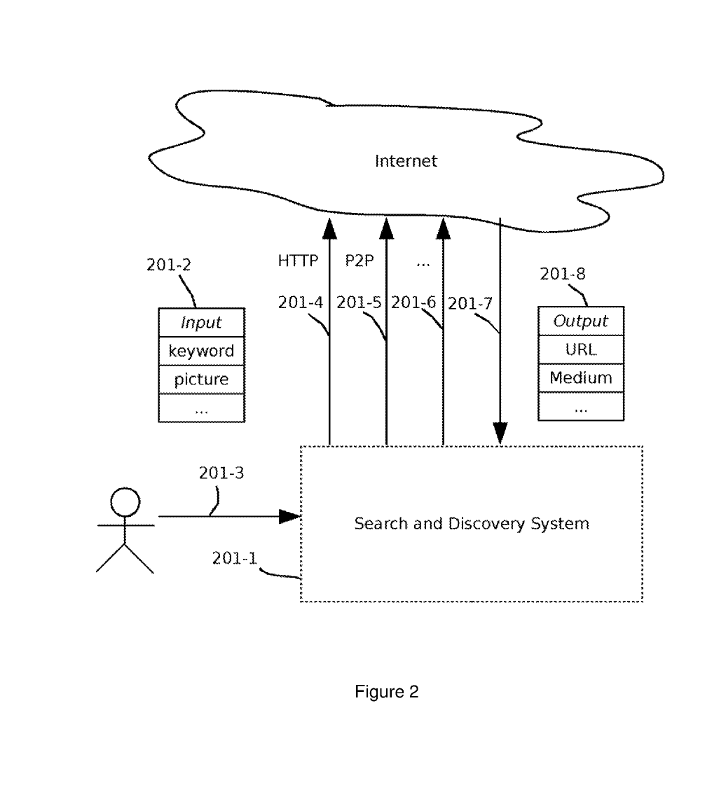

FIG. 2 illustrates the search and discovery system in depth, which corresponds to 101 in FIG. 1. Inside this Figure, 201-2 lists possible inputs for search and discovery system, including text keywords, descriptive images and even audios etc. which are searchable by search engines. 201-3 indicates that the search and discover system also accepts manually inputs of searching conditions. Based on the various searching conditions, the search and discover system applies multiple protocols to perform search over the Internet. The protocols supported at this point include HTTP for websites, and ed2k, BT, etc for P2P resources. Practically, such search and discovery require entries to access information from the Internet, therefore URLs (Uniform Resource Locator) for typical online video sharing sites and P2P nodes are maintained and managed in an augmented list, wherein “augmented” means the list is self extendable through the process of discovery. In other word, when the website crawler is collecting targeted information from the Internet, it not only searches for the potential candidates for identification, but also discovers relevant keywords to keep in the pool of searching conditions and parses related resource URLs or P2P nodes for the use of further discovery. The discovered new information or resource links are then recorded in the augmented list or other data tables after confirming from administrator.

The output of search and discover system is shown in 201-8, which contains the semantically relevant or closely matched video sharing webpage URLs or the video resources in p2p networks. Considering the massive amount of websites and resources on the Internet, even though they have been narrowed down by matching to texts or other means of characteristics, the quantity is still overwhelming for limited identification processing resources. Therefore, further actions will be taken, as is described in FIG. 3.

FIG. 3 is a block diagram describing the filtration system which contributes to significantly reduce the processing effort of the identification function of the tracking system, yet remains the broad coverage and high rated accuracy of the purpose of tracking down targeted video contents over the whole Internet. As pointed in FIG. 3, the input of filtration system is the result from search and discovery system, which contains a list of video sharing webpage URLs and p2p network resources that are roughly matched the target searching conditions by semantic level. The filtration system is equipped with several filters (as drawn in block 302) of different protocols and different criteria.

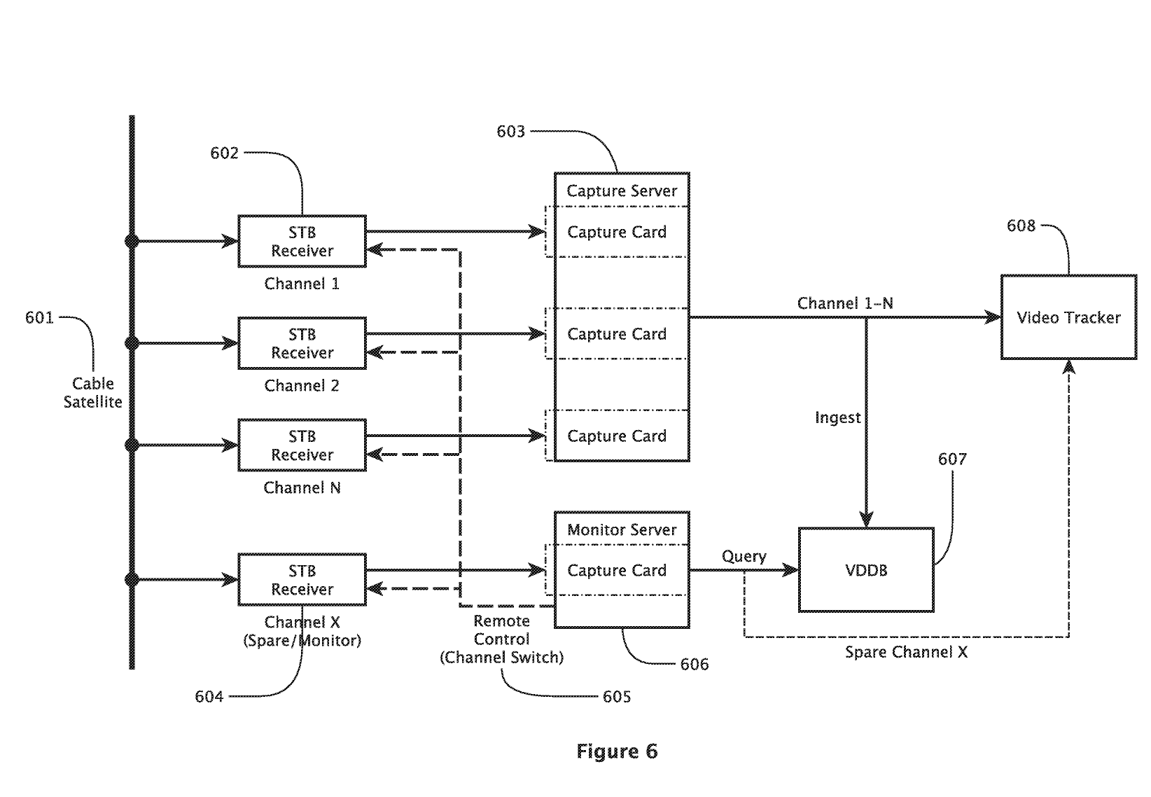

As an example, an internal workflow of HTTP filter is depicted in 301. Online video contents are often embedded in webpages of video sharing websites, in the form of a FLASH movie or HTML5 video tag. In order to extract information from these various websites, we have established a template system, which manages sets of templates to adapt different webpages. With the help of templates, it is possible to extra valuable metadata from webpages, wherein, such metadata includes webpage URL, video URL (if not hidden), video title, video publishing time, video duration, audience ratings and comments and much more. These metadata have two obvious purpose to video tracking system: 1) with these information it is possible to greatly reduce the amount of candidate items and filter out much more accurate video contents to be further identified, for example, if the targeted video is released on a certain date, any video contents published before that date are out of the scope, hence the video contents to be identified should conform to combinations of filter criteria; 2) the metadata extracted from video websites also reveals many properties of the video content, such as trends, popularity, user preferences, etc, and these properties when collected and after data mining, can be important data for content owners to measure some indexes of the online video content or blocks for analyzing user behavior regarding to a certain video content, as will be discussed in detail in FIG. 6.

Each type of file sharing contains the base information of the content as well as P2P. They may be file size, file name and so on. Video contents may have larger size with more length, for example, videos with about 7 minutes must be larger than 10 MB in general. P2P filters may filter out videos that do not match the base information at first time such as files with less than 1 MB in size, or telling others they are videos longer than 120 mins. Videos with earlier publish time than targeted videos will filter out as well. There are much information provided by P2P networks which we can use when filtering.

So we may define a template for the targeted video and targeted P2P network where the template may be a set of properties with limited range of values. Videos with properties out of range of the template can be excluded when applying filters.

The output of the filtration system has two divisions, either the item has gone through all designed filters which means it is reasonable to consider that this video content matches most of the external characteristics of the targeted video content in many aspects, then it will be put on a best candidate queue for further identification process, or the item does not fulfill the filter criteria, and it will be discarded from this round of tracking.

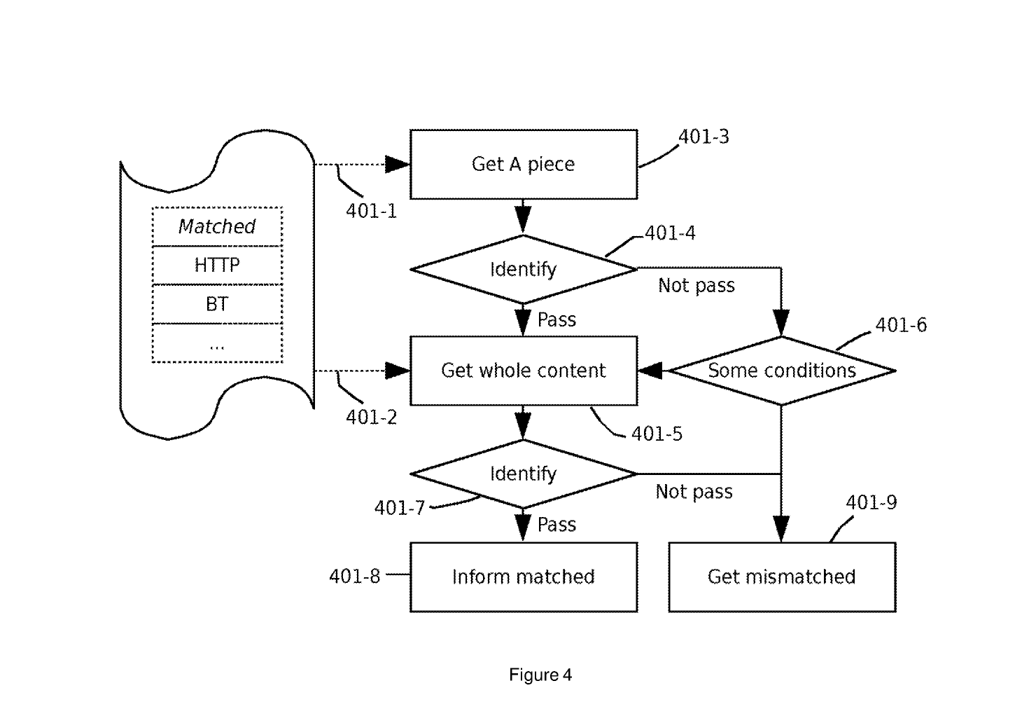

FIG. 4 illustrates the core function of the invented method and system in a flow chart: the identification system, which can be simply referred to as using VDNA technology to match each entry in the best candidate queue generated by the filtration system, where VDNA technology refers to the video content identification technology to take advantage of the high speed processing of the computers to ingest characteristic values of each frame of image and audio from video contents. Due to the fact that VDNA technology is entirely based on the video content itself between video content and generated VDNA, there is an one-to-one mapping relationship. Furthermore, the matching technique for the two instances of VDNA (the one ingested from input video content and the one from targeted video content which is registered beforehand in the dedicated database), applies algorithms to be not only able to identify exact characteristics, but also allow changes on the video content, for example, image rotation, limited scaled distortion, cropping of the video frames, inconsistent frames and many more. Therefore it is reasonable to consider by matching the input video contents with the targeted video contents which are already registered in the dedicated database, to be able to identify the input video content with a very accurate rate.

The inputs for the identification system are the best candidate list outputted by filtration system, which is a list of potentially matched items of URLs or resource descriptions of video contents. In order to ingest VDNA characteristics from them for matching purpose, the identification system is required at the first place to acquire these video contents from the Internet. There are various means for acquiring online video contents, including automation scripts to capture the playing screen, downloading video files or capturing the network packet and so on.

Given the fact that online video files are always large in size, in consideration of bandwidth and hardware limitation, some means of optimization can be applied, which includes:
as demonstrated in 401-3, the identification system can acquire only the first few parts of the online video content, which is greatly smaller compared to the whole video content, and the acquired parts of the video content is identified by the system. This is possible because of the advantages of VDNA technology, that VDNA can be ingested from any valid format of video contents,
exact matching by VDNA is not necessary, and the matching algorithm tolerates inputs of different length, rotation or cropping of the video contents and so on,
VDNA ingestion and query are swift and compact, and processing only heading parts of the video content can rapidly discard those negative items at the very beginning, as well as saving huge portion of processing efforts, resources and time.
the online video acquiring process can also be constrained by some conditions.

The identified items will be collected and detailed reports containing metadata of the identified video content, online distribution and status of the video content, as well as other information preferred by content owner will be generated.

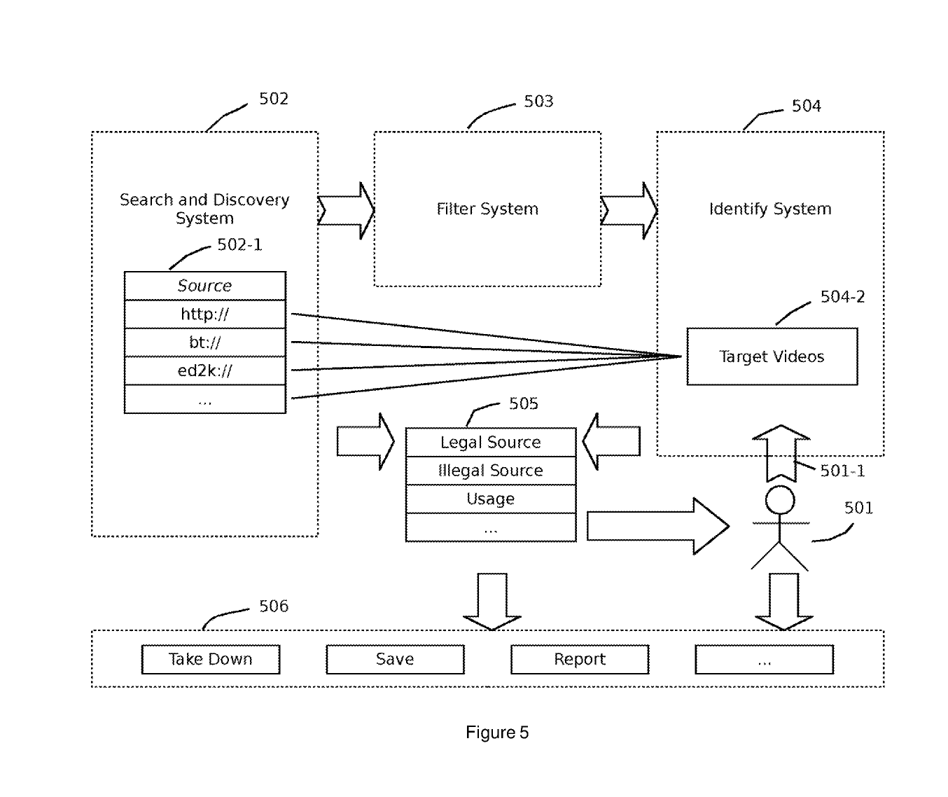

FIG. 5 demonstrates the workflow of video tracking system from user's perspective, and reveals some concerns that users might be interested in, wherein the “user” as depicted in diagram 501 refers to 1) entities who own or have registered video contents, such as content owners or authorized agents, 2) organizations having the responsibility to track or monitor pirated or illegal online video contents. Users are required to register (action 501-1) the metadata and characteristics (as known as VDNA) of the target video content (504-2) into video identification system (504). Then the system 502 will be launched to search and discover qualified resources over the Internet using the provided video metadata, at the same, time system 502 also collects and organizes relevant information (block 505 and 506) while it analyzes online video websites or p2p network resources. The amount of qualified video resources discovered by system 502 will be massive, and filtration system 503 is applied to tremendously narrow down the results so that the video contents to be identified will be more accurate and thus save a lot of hardware and bandwidth resources as well as processing time. Identification system 504 will process each items outputted from filtration system, to ingest VDNA from those items and match with the targeted video content (504-2). The users are able to take actions according to the identification result from the system, and such actions (506) include taking down notices for illegal video contents, saving evidence of the video content and so on. The identified results will also be combined with the video information collected at the point of discovery (block 506) and a report with information on users concern, such as online video distribution status, illegal copies of the targeted video, audience usage of the videos, and so on, will be generated.

In conclusion, an online video tracking and identifying method and system of the present invention include:

A method for identifying and tracking online videos comprises:
a) searching and discovering targeted video on the Internet, including using a set of predefined keywords, applying mature Internet crawler technology and P2P (point-to-point) technology to search throughout an augmented list of websites and the aforementioned P2P resources, and
b) filtering out manageable amount of online videos from large amount of search results of the aforementioned targeted video.

The aforementioned augmented list of websites is created and managed by a Search and Discovery System based on the entire Internet, which executes search based on keywords, images or audio throughout the entire Internet, and captures text contents from targeted websites or from captured text information, and the aforementioned Search and Discovery System heuristically discovers new websites, and adds it to the aforementioned augmented list after confirming from administrator.

The source of the aforementioned searching and discovering on the Internet includes online video websites and the aforementioned P2P networks.

The aforementioned Internet crawler technology can be HTTP (Hypertext Transfer Protocol) crawler that starts with an given URL (Uniform Resource Locator) of web page, grabs everything and finds out links presented on web page, then grabs everything recursively from the aforementioned grabbed URLs, wherein the aforementioned search and discovery system can find out web pages that contain the aforementioned targeted videos.

The aforementioned Internet crawler technology can refer to crawlers that depend on type of file-sharing networks wherein the aforementioned P2P crawler being one of those crawlers which are used for crawling the aforementioned P2P networks such as BT (Bit Torrent) and eD2k (eDonkey 2000), wherein the aforementioned crawling function depending on the characteristics of targeted network, and the aforementioned method of crawling the aforementioned eD2k network comprising the aforementioned crawler sending a keyword to the aforementioned eD2k server to get a related list of files from server, finding out targeted files, retrieving a list of peers that own content of the aforementioned targeted file, and getting a shared file list from the aforementioned each peer to find more files, then asking the aforementioned server repeatedly and discovering recursively.

The aforementioned filtering criteria includes keyword text pre-processing based on keyword weight, sensitivity, scope and duration to filter out best matches of video contents.

The aforementioned filtering criteria also includes using video metadata, such as publish time and duration, to filter out best matches of video contents.

The aforementioned filtering system performs further pre-process on list of video contents to be identified, based on the highly effective and compact feature of Video DNA (VDNA) technology by examining only first predefined-sized portion of the aforementioned video content, to filter out best matches of the aforementioned video contents.

A method for identifying and tracking online videos comprises:
a) searching and discovering targeted video on the Internet,
b) filtering out manageable amount of the aforementioned online videos from large amount of search results of the aforementioned targeted video,
c) acquiring the aforementioned online video contents through websites,
d) identifying the aforementioned acquired videos by contents, wherein an identification process is not by keywords nor by tags as used by conventional methods, but by using Video DNA (VDNA) matching to optimize the result, and
e) generating different tracking reports as shown in video identification results and historical records.

Based on the result of the aforementioned filtering, the aforementioned method determines a list of videos whose metadata have targeted characteristics, and acquires the aforementioned listed online video contents from the aforementioned websites, and the aforementioned acquired video contents are used for the aforementioned VDNA identification and saved on record, wherein the aforementioned method of acquiring the aforementioned online video contents supporting multiple protocols.

The aforementioned acquiring online video contents can include capturing a displaying screen, downloading and capturing network packets.

The aforementioned VDNA is de facto an advanced video content identification technology which provides swift and accurate match of the aforementioned video contents by comparing ingestion of characteristics of video and audio contents.

The aforementioned VDNA can be ingested from any valid format of the aforementioned video content and the aforementioned video content identification heavily relies on the accuracy and swiftness of the aforementioned VDNA technology.

The aforementioned content identification is able to analyze clipping status of the aforementioned video content so as to effectively identify videos which have been edited or substituted.

The aforementioned content identification is also used as feedback to improve searching, discovering and filtering process.

A system for identifying and tracking online videos comprises VIDEOTRACKER® subsystem of searching and discovering targeted video on the Internet, filtering out manageable amount of online videos from large amount of search results of the aforementioned targeted video, acquiring online video contents through websites, identifying the aforementioned acquired videos by their contents, and generating different tracking reports as obtained in video identification results and other historical records.

The aforementioned VIDEOTRACKER® comprising a search and discovery component entity whose functionality is to discover the aforementioned video contents on the Internet which have targeted characteristics in the form of video metadata, video format, and different means or protocols.

The aforementioned VIDEOTRACKER® comprising a filtration component entity which filters out a manageable quantity of the aforementioned video contents from the massive amount of search results.

The aforementioned VIDEOTRACKER® comprising a video content identification component entity which ingests Video DNA (VDNA) from the aforementioned video contents and manages the aforementioned VDNA information in dedicated databases.

The method and system of the present invention are based on the proprietary architecture of the aforementioned VDNA® and VIDEOTRACKER® platforms, developed by Vobile, Inc, Santa Clara, Calif.

### Improvements in the Present Continuation Application

The present continuation application is to extend the range of content monitoring from the Internet to TV broadcasting network, including wireless, wired and satellite networks.

For comparison, the parent application covers the following key disclosures:

The object of the parent application is to automatically and accurately identify and track targeted video contents over the Internet, by using limited resources to cover massive amount of information on the Internet.

The present continuation invention continues on from the parent application and extends to disclose:

A minimum requirement for monitoring TV broadcasting networks consists of a set of STB (Set-top Box) receivers 602 which receive broadcasting signals from various transmission media such as cable, satellite, etc (shown in 601), and a capture server 603 equipped with multiple capture cards for transcoding the broadcasting signals and storing said signals as specific video and audio formats for further analysis or operations, for instance using in Video Tracker 608 for the purpose of preventing piracy.

In order to achieve the need of continuous monitoring, said STB receivers are required to be persistently in working state on a 24×7 basis. However, most STB receivers are commercial electronics designed for domestic use, stability over long duration of usage may not be the primary design features for such devices, therefore malfunctions such as blackout, reboots, or channel switches unexpectedly may occur when the STB receivers are constant powered on and processing broadcasting signals. Most STB receivers are not equipped with an external interface to report said malfunctions due to cost consideration.

Said potential malfunctions hinder the process of continuous monitoring on TV broadcasting contents in a closed automatic system. The capture server may be programmed to notify administrators in the case of signal breaks from STBs. But said capture server is not able to detect other malfunctions occurred on the STBs such as channel error, absence of audio/video tracks, etc. All video and audio recorded in said capture server for further analysis and operations are invalid after the time of a certain STB failure. Since there's no effective error report interface from common commercial STB receivers, said failure is not possible to automatically discovered and recovered. The present continuation invention discusses a method and system to address this problem.

A set of spare STB receivers 604, an additional monitor server 606 and a media content identification service 607 are added to said automatic monitoring system. Said monitor server has a remote control module 605, which can be programmed to send control instructions such as channel switch to STB receivers.

The channel signal confirmation workflow is listed as follows:

Said multiple channels of TV broadcasting signals are transmitted via STB receivers and captured by said capture server normally.

Besides storing copies of captured video and audio in said capture server, the contents from said TV broadcasting channels are also constantly ingested into an audio and video content identification service, such as VDDB.

Said monitor server sends channel switch instructions via remote control module repeatedly to the set of spare STB receivers, and captures media contents from the spare STB receivers respectively with their channel IDs. Said channel switch instructions will cover the entire set of channels one by one from all available TV broadcasting networks. Said channel switch instructions will be sent periodically ensuring the operating channel is identified and confirmed.

Said captured media contents from the spare STB receivers and their corresponding channel IDs are sent to said media content identification server, such as VDDB, for realtime query against said ingested audio and video contents from said capture server.

The result of the identification is used to confirm or deny the validity of the corresponding signal from a certain STB receiver. And follow-up operations will be automatically performed accordingly.

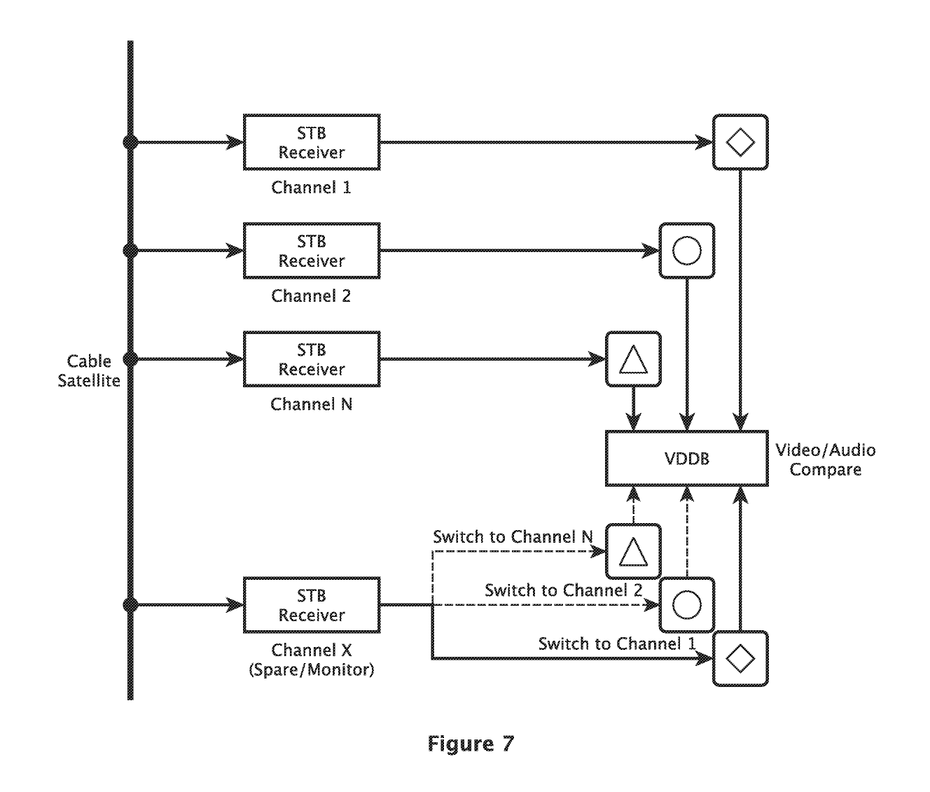

The compare process between signals from original STB receivers and spare STB receivers is depicted in FIG. 7. Said spare STB receiver is instructed to switch channel periodically, and the signals captured from current channel will be used to compare with the contents from corresponding monitoring channel by VDDB identification service.

If the compare result is positive, the monitoring channel is confirmed valid. Otherwise certain operations may be taken to automatically recover the failed channel.

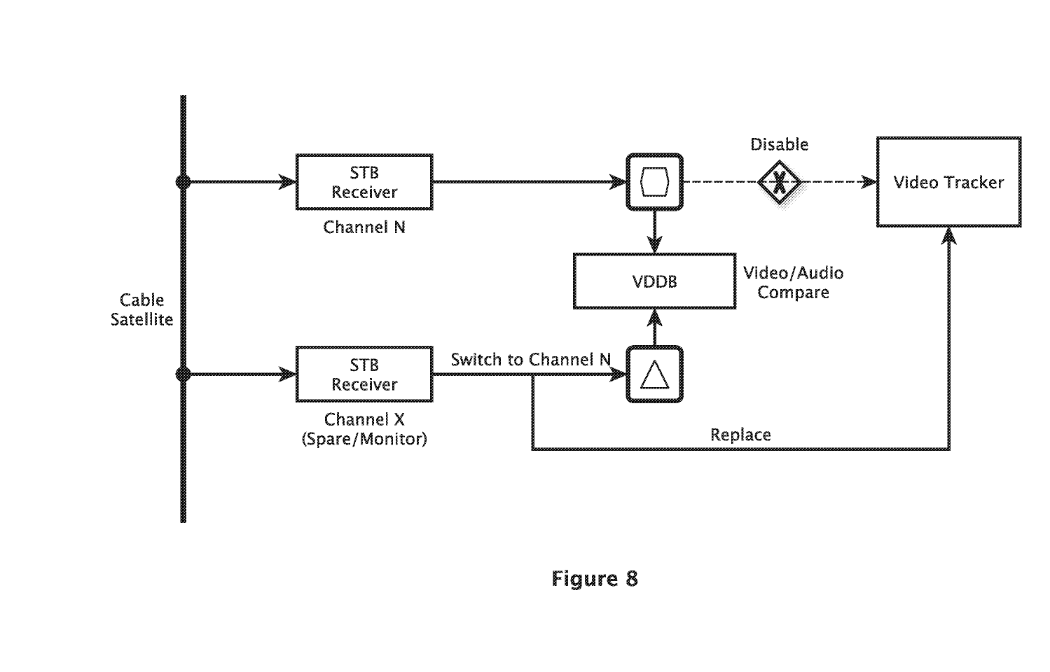

FIG. 8 depicts one of the measures taken to recover the valid status of the system. When a failed channel is flagged, the operations on said failed channel will be suspended, for instance the audio and video content captured from said failed channel will stop sending to and processing by Video Tracker. In replacement, one of the spare STB receivers will be switched to and tagged as the original channel and its output will be used thereafter. The state of the monitoring system remains valid and consistent. Notifications can be setup to notify administrators on failed STB receivers

In summary, the present invention discloses the following merits:

A method of content monitoring on TV (television) broadcasting networks comprises:
a) an automatic and continuous mechanism to receive and transcode TV broadcasting signals through a set of capture servers, and transcoded signals used for further analysis or operations, and
b) an automatic recovery method enforced to guarantee 24×7 availability of monitoring process, and said automatic recovery method including a channel signal confirmation workflow and a failure correction process when any STB (set top box) failure occurring.

The TV broadcasting signals are received from various TV broadcasting networks including wireless, wired or satellite networks.

The TV broadcasting signals are received by a set of STB (Set-top Box) receivers.

A set of capture servers are applied to receive relay signals from said STB receivers and transcode said signals to specific video and audio formats for further analysis or operations.

The channel signal confirmation workflow comprises a set of spare STB receivers, an additional monitor server and a media content identification server that are applied to perform said channel signal confirmation workflow, and said monitor server has a remote control module which is programmed to send control instructions such as channel switch to said STB receivers.

The channel signal confirmation workflow comprises a set of capture servers constantly ingesting captured video and audio contents into said identification server.

The channel signal confirmation workflow comprises monitor server that sends channel switch instructions via remote control module repeatedly to the set of spare STB receivers, and captures media contents from the spare STB receivers respectively with their channel IDs (identifiers), and said channel switch instructions cover the entire set of channels one by one from all available TV broadcasting networks, and said channel switch instructions are sent periodically to ensure that operating channel is identified and confirmed.

The channel signal confirmation workflow comprises the captured media contents from the spare STB receivers and their corresponding channel IDs are sent to said media content identification server for real-time match against said ingested audio and video contents from said capture server.

The channel signal confirmation workflow comprises the result of said identification which is used to confirm or deny the validity of the corresponding signal from a certain STB receiver.

The failure correction process comprises one of the spare STB receivers which is automatically switched to and tagged as a replaced channel with its output to be used thereafter.

The failure correction process comprises notifications which are set up to notify administrators on failed STB receivers.

A system of content monitoring on TV (television) broadcasting networks comprises:
a) a set of STB (Set-top Box) receivers which receive broadcasting signals from various TV broadcasting transmission media, and a set of capture servers equipped with multiple capture cards for transcoding broadcasting signals and storing said signals with specific video and audio formats for further analysis or operations, and
b) an additional confirmation subsystem to perform channel signal confirmation workflow and failure correction process.

Besides storing copies of captured video and audio, said set of capture servers also constantly ingest captured video and audio contents into identification server.

The confirmation subsystem comprises a set of spare STB receivers, an additional monitor server and a media content identification server.

The monitor server has a remote control module that is programmed to send control instructions such as channel switch to STB receivers.

The monitor server sends channel switch instructions via said remote control module repeatedly to the set of spare STB receivers, and captures media contents from the spare STB receivers respectively with their channel IDs (identifiers).

The captured media contents from the spare STB receivers and their corresponding channel IDs are sent to said media content identification server for real-time match against said ingested audio and video contents from said capture server.

The result of said identification is used to confirm or deny the validity of the corresponding signal from a certain STB receiver.

The confirmation subsystem comprises one of the spare STB receivers which is automatically switched to and tagged as a replaced channel with its output to be used thereafter when a failed channel is detected by said confirmation subsystem.

The method and system of the present invention are not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one ordinary skilled in the art to which the present invention pertains having the benefit of the teachings presented in the foregoing descriptions. Therefore, it is to be understood that the present invention is not to be limited to the specific examples of the embodiments disclosed and that modifications, variations, changes and other embodiments are intended to be included within the scope of the appended claims. Although specific terms are employed herein, they are used in a generic and descriptive sense only and not for purposes of limitation.

What is claimed:

1. A method of content monitoring on TV (television) broadcasting networks, said method comprising:
a) an automatic and continuous mechanism to receive and transcode TV broadcasting signals through a set of capture servers, and transcoded signals used for further analysis or operations, and
b) an automatic recovery method enforced to guarantee 24×7 availability of monitoring process, and said automatic recovery method including a channel signal confirmation workflow and a failure correction process when any STB (set top box) failure occurring.

2. The method as recited in claim 1, wherein said TV broadcasting signals are received from various TV broadcasting networks including wireless, wired or satellite networks.

3. The method as recited in claim 1, wherein said TV broadcasting signals are received by a set of STB (Set-top Box) receivers.

4. The method as recited in claim 1, wherein said a set of capture servers are applied to receive relay signals from said STB receivers and transcode said signals to specific video and audio formats for further analysis or operations.

5. The method as recited in claim 1, wherein said channel signal confirmation workflow comprises a set of spare STB receivers, an additional monitor server and a media content identification server that are applied to perform said channel signal confirmation workflow, and said monitor server has a remote control module which is programmed to send control instructions such as channel switch to said STB receivers.

6. The method as recited in claim 1, wherein said channel signal confirmation workflow comprises a set of capture servers constantly ingesting captured video and audio contents into said identification server.

7. The method as recited in claim 1, wherein said channel signal confirmation workflow comprises monitor server that sends channel switch instructions via remote control module repeatedly to the set of spare STB receivers, and captures media contents from the spare STB receivers respectively with their channel IDs (identifiers), and said channel switch instructions cover the entire set of channels one by one from all available TV broadcasting networks, and said channel switch instructions are sent periodically to ensure that operating channel is identified and confirmed.

8. The method as recited in claim 1, wherein said channel signal confirmation workflow comprises the captured media contents from the spare STB receivers and their corresponding channel IDs are sent to said media content identification server for real-time match against said ingested audio and video contents from said capture server.

9. The method as recited in claim 1, wherein said channel signal confirmation workflow comprises the result of said identification which is used to confirm or deny the validity of the corresponding signal from a certain STB receiver.

10. The method as recited in claim 1, wherein said failure correction process comprises one of the spare STB receivers which is automatically switched to and tagged as a replaced channel with its output to be used thereafter.

11. The method as recited in claim 1, wherein said failure correction process comprises notifications which are set up to notify administrators on failed STB receivers.

12. A system of content monitoring on TV (television) broadcasting networks, said system comprising:
a) a set of STB (Set-top Box) receivers which receive broadcasting signals from various TV broadcasting transmission media, and a set of capture servers equipped with multiple capture cards for transcoding broadcasting signals and storing said signals with specific video and audio formats for further analysis or operations, and
b) an additional confirmation subsystem to perform channel signal confirmation workflow and failure correction process.

13. The system as recited in claim 12, besides storing copies of captured video and audio, said set of capture servers also constantly ingest captured video and audio contents into identification server.

14. The system as recited in claim 12, wherein said confirmation subsystem comprises a set of spare STB receivers, an additional monitor server and a media content identification server.

15. The system as recited in claim 14, wherein said monitor server has a remote control module that is programmed to send control instructions such as channel switch to STB receivers.

16. The system as recited in claim 14, wherein said monitor server sends channel switch instructions via said remote control module repeatedly to the set of spare STB receivers, and captures media contents from the spare STB receivers respectively with their channel IDs (identifiers).

17. The system as recited in claim 16, wherein said captured media contents from the spare STB receivers and their corresponding channel IDs are sent to said media content identification server for real-time match against said ingested audio and video contents from said capture server.

18. The system as recited in claim 17, wherein the result of said identification is used to confirm or deny the validity of the corresponding signal from a certain STB receiver.

19. The system as recited in claim 12, wherein said confirmation subsystem comprises one of the spare STB receivers which is automatically switched to and tagged as a replaced channel with its output to be used thereafter when a failed channel is detected by said confirmation subsystem.
